(19) United States
(12) Patent Application Publication
(10) Pub. No.: US 2025/0077862 A1
(43) Pub. Date: Mar. 6, 2025

(54) METHOD, PROGRAM, AND DEVICE FOR TRAINING ARTIFICIAL NEURAL NETWORK BASED ON ADAPTIVE STOCHASTIC GRADIENT DESCENT IN MEMORY-BASED CONTINUAL LEARNING SITUATION

(71) Applicant: SEOUL NATIONAL UNIVERSITY R&DB FOUNDATION, Seoul (KR)

(72) Inventors: Lee JUNGWOO, Seoul (KR); Han SEUNGYUB, Seoul (KR); Kim YEONGMO, Seoul (KR); Cho TAEHYUN, Seoul (KR)

(21) Appl. No.: 18/756,210

(22) Filed: Jun. 27, 2024

(30) Foreign Application Priority Data
Sep. 6, 2023 (KR) 10-2023-0118139

(51) Int. Cl. G06N 3/08

(52) U.S. Cl. CPC G06N 3/08

(57) ABSTRACT

According to an aspect of the present invention, there is provided a method of training an artificial neural network based on a memory-based continual learning algorithm, which is performed by a computing device including at least one processor. The method includes: storing part of previous training data, used in previous training, in memory; for an artificial neural network trained using the previous training data, computing adaptive learning rates to be applied to the artificial neural network based on a first gradient for first batch data sampled from the memory and a second gradient for second batch data including part of new training data; and training the artificial neural network based on the first batch data, the second batch data, and the adaptive learning rates.

### DESCRIPTION OF GOVERNMENT-FUNDED RESEARCH AND DEVELOPMENT

The present disclosure is made with the support of the Ministry of Science and ICT, Republic of Korea, under the following project identifications and numbers:

Project Identification No. 1711193316 and Project No. 2021-0-00106-003, which was conducted in the task named “Development of Accelerator Optimization-Based Artificial Neural Network Automatic Generation Technology and Open Service Platform” in the research project named “SW Computing Industry Original Technology Development”, by the Research & Business Foundation of Seoul National University, under the research management of the Institute of Information & Communications Technology Planning & Evaluation (IITP), from Apr. 1, 2021, to Dec. 31, 2024, with a contribution rate of 50/100.

Project Identification No. 1711193789 and Project No. 2021-0-01059-003, which was conducted in the task named “Solving Batch Learning Optimization Problems for Quantum Deep Learning” in the research project named “SW Computing Industry Original Technology Development”, by the Research & Business Foundation of Seoul National University, under the research management of the Institute of Information & Communications Technology Planning & Evaluation (IITP), from Apr. 1, 2021, to Dec. 31, 2024, with a contribution rate of 50/100.

### CROSS-REFERENCE TO RELATED APPLICATION

This application claims the benefit of Korean Patent Application No. 10-2023-0118139 filed on Sep. 6, 2023, which is hereby incorporated by reference herein in its entirety.

### BACKGROUND

### 1. Technical Field

The present disclosure relates to a method, program, and device for training an artificial neural network based on adaptive stochastic gradient descent to prevent the artificial neural network from losing convergence for previous training data based on a nonconvex optimization theory in a memory-based continual learning situation.

### 2. Description of the Related Art

Memory-based continual learning in a system using an artificial neural network refers to a learning methodology in a situation where different types of new training data tasks come in a time-series manner. This learning methodology performs the task of learning new training data, but maintains performance for previously learned training data without loss by using data stored in a small amount of memory.

In general, an artificial neural network is trained on generalized patterns using large-scale data. However, in a real environment, new data that is different from previous training data is inevitably generated continuously. Accordingly, in continual learning, new data is continuously learned to compensate for the defect of a previous artificial neural network.

In this case, data access to previous training data is inevitably limited, so that a phenomenon called catastrophic forgetting occurs. Accordingly, one of the goals of continual learning is to prevent catastrophic forgetting that occurs when multiple tasks are learned sequentially.

Conventional continual learning methods can be divided into a method using gradient descent or a method not using it. The method using gradient descent has the problem of not being able to theoretically guarantee the degree of convergence and degree of performance change between previous training data and new training data, and also has a limitation in measuring them quantitatively.

Therefore, there is a demand for a method of actively preventing the phenomenon in which performance for previous training data is reduced, which is called catastrophic forgetting. Furthermore, there is also a demand for a method of quantitatively measuring the degree of convergence and degree of performance change for previous training data.

### SUMMARY

The present invention has been conceived in response to the background technology, and an object of the present disclosure is to provide a continual learning algorithm that may minimize the reduction of performance for previous training data and may allow adaptive learning rates to be set for the previous training data and new training data, respectively.

Another object of the present disclosure is to provide indicators that may quantify learning performance, such as bias and the degree of forgetting, in order to objectively evaluate the performance of a learning algorithm.

However, objects to be accomplished by the present disclosure are not limited to the objects mentioned above, and other objects not mentioned may be clearly understood based on the following description.

According to an aspect of the present invention, there is provided a method of training an artificial neural network based on a memory-based continual learning algorithm, which is performed by a computing device including at least one processor. The method includes: storing part of previous training data, used in previous training, in memory; for an artificial neural network trained using the previous training data, computing adaptive learning rates to be applied to the artificial neural network based on a first gradient for first batch data sampled from the memory and a second gradient for second batch data including part of new training data; and training the artificial neural network based on the first batch data, the second batch data, and the adaptive learning rates.

Computing the adaptive learning rates may include computing a first adaptive learning rate to be reflected in the first gradient and a second adaptive learning rate to be reflected in the second gradient based on the inner product of the first and second gradients.

Computing the first adaptive learning rate to be reflected in the first gradient and the second adaptive learning rate to be reflected in the second gradient may include computing the first adaptive learning rate to be a constant when the inner product of the first and second gradients is larger than 0 and computing the second adaptive learning rate to be a constant when the inner product of the first and second gradients is smaller than or equal to 0.

The first adaptive learning rate may be calculated according to Equation 1 below when the inner product of the first and second gradients is smaller than or equal to 0:

$$α ( 1 - \frac{{Λ}_{{H}_{t}}}{{‖ ∇ {f}_{{I}_{t}} ( {x}^{{}_{t}} ) ‖}^{2}} ) \qquad ( 1 )$$

where:
α: a basic constant learning rate (a constant)
Λ_{H}_{ₜ}: the inner product of the first gradient ∇f_{I}_{ₜ}(x^{t}) and the second gradient ∇g_{J}_{ₜ}(x^{t})
∇f_{I}_{ₜ}(x^{t}): the first gradient.

The second adaptive learning rate may be calculated according to Equation 2 below when the inner product of the first and second gradients is larger than 0:

$$min ( α ( 1 - δ ) , \frac{( 1 - α L ) {Λ}_{{H}_{t}}}{L {‖ ∇ {g}_{{J}_{t}} ( {x}^{{}_{t}} ) ‖}^{2}} ) \qquad ( 2 )$$

where:
α: a basic constant learning rate (a constant)
δ: a constant larger than 0 and considerably smaller than 1
L: a Lipschitz smoothness constant
∇f_{I}_{ₜ}(x^{t}): the first gradient
∇g_{J}_{ₜ}(x^{t}): the second gradient
Λ_{H}_{ₜ}: the inner product of the first and second gradients.

Training the artificial: neural network may include updating the parameters of the artificial neural network according to Equation 3 below:

$${{x}^{}}^{t + 1} = {x}^{t} - {α}_{{H}_{t}} ∇ {f}_{{I}_{t}} ( {x}^{t} ) - {β}_{{H}_{t}} ∇ {g}_{{J}_{t}} ( {x}^{t} ) \qquad ( 3 )$$

where:
∇f_{I}_{ₜ}(x^{t}): the first gradient
∇g_{J}_{ₜ}(x^{t}): the second gradient
x^{t+1}: the updated parameters of the artificial neural network
x^{t}: the parameters of the artificial neural network before update
α_{H}_{ₜ}: the first adaptive learning rate
β_{H}_{ₜ}: the second adaptive learning rate
Hₜ: the union of the first batch data and the second batch data.

The bias Bₜ of the artificial neural network that occurs as the first batch data is used may be calculated according to Equation 4 below:

$${B}_{t} = ( L {α}_{{H}_{t}}^{2} - {α}_{{H}_{t}} ) 〈 ∇ {f}_{{I}_{t}} ( {x}^{t} ) , {e}_{t} 〉 + {β}_{{H}_{t}} 〈 ∇ {g}_{{J}_{t}} ( {x}^{t} ) , {e}_{t} 〉$$

(4) where:
L: a Lipschitz smoothness constant
α_{H}_{ₜ}: the first adaptive learning rate
β_{H}_{ₜ}: the second adaptive learning rate
∇f_{I}_{ₜ}(x^{t}): the first gradient
∇g_{J}_{ₜ}(x^{t}): the second gradient
eₜ: bias error between an average gradient ∇f(x^{t}) for the previous training data and the first gradient.

The forgetting term Γₜ of convergence for the previous training data calculated in step t, which is used to calculate the average degree of forgetting for the previous training data of the artificial neural network model caused by the second batch data, may be calculated according to Equation 5 below:

$${Γ}_{t} = \frac{{β}_{{H}_{t}}^{2} L}{2} {‖ ∇ {g}_{{J}_{t}} ( {x}^{t} ) ‖}^{2} - {β}_{{H}_{t}} ( 1 - {α}_{{H}_{t}} L ) 〈 ∇ {f}_{{I}_{t}} ( {x}^{t} ) , ∇ {g}_{{J}_{t}} ( {x}^{t} ) 〉$$

(5) where:
α_{H}_{ₜ}: the first adaptive learning rate
β_{H}_{ₜ}: the second adaptive learning rate
L: a Lipschitz smoothness constant
∇f_{I}_{ₜ}(x^{t}): the first gradient
∇g_{J}_{ₜ}(x^{t}): the second gradient.

The average degree of forgetting E[Γₜ*] may be calculated according to Equation 7 below when the second adaptive learning rate is an optimal value β_{H}_{ₜ}*, represented by Equation 6 below:

$${β}_{{H}_{t}}^{*} = \frac{( 1 - {α}_{{H}_{t}} L ) {Λ}_{{H}_{t}}}{L {‖ ∇ {g}_{{J}_{t}} ( {x}^{t} ) ‖}^{2}} \qquad ( 6 )$$

$$E [ {Γ}_{t}^{*} ] = \frac{( 1 - {α}_{{H}_{t}} L ) {Λ}_{{H}_{t}}}{2 L {‖ ∇ {g}_{{J}_{t}} ( {x}^{t} ) ‖}^{2}} \qquad ( 7 )$$

where:
Γₜ*: the minimum value of the forgetting term of the convergence calculated at step t
Λ_{H}_{ₜ}: the inner product of the first and second gradients.

The memory may store the previous training data by using a ring buffer or reservoir sampling method.

According to another aspect of the present invention, there is provided a computer program stored in a computer-readable storage medium. The computer program performs the operations of training an artificial neural network based on a memory-based continual learning algorithm when executed on at least one processor. In this case, the operations include the operations of: storing part of previous training data, used in previous training, in memory; for an artificial neural network trained using the previous training data, computing adaptive learning rates to be applied to the artificial neural network based on a first gradient for first batch data sampled from the memory and a second gradient for second batch data including part of new training data; and training the artificial neural network based on the first batch data, the second batch data, and the adaptive learning rates.

According to still another aspect of the present invention, there is provided a computing device for training an artificial neural network based on a memory-based continual learning algorithm. The computing device includes: a processor including at least one core; and memory including program codes that are executable on the processor, and configured to store part of previous training data used in previous training. In this case, the processor computes, for an artificial neural network trained using the previous training data, adaptive learning rates to be applied to the artificial neural network based on a first gradient for first batch data sampled from the memory and a second gradient for second batch data including part of new training data, and trains the artificial neural network based on the first batch data, the second batch data, and the adaptive learning rates.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram of a computing device according to an embodiment of the present disclosure;

FIG. 2 is an exemplary diagram illustrating a method of training an artificial neural network according to an embodiment of the present disclosure;

FIG. 3 is an exemplary diagram showing an algorithm for a method of training an artificial neural network according to an embodiment of the present disclosure;

FIG. 4 is a flowchart showing a method of training an artificial neural network according to an embodiment of the present disclosure;

FIG. 5 is a table showing the performance of a method of training an artificial neural network according to an embodiment of the present disclosure; and

FIGS. 6A through 6F are graphs showing the performance of a method of training an artificial neural network according to an embodiment of the present disclosure.

### DETAILED DESCRIPTION

Embodiments of the present disclosure will be described in detail below with reference to the accompanying drawings so that those having ordinary skill in the art of the present disclosure (hereinafter referred to as those skilled in the art) can easily implement the present disclosure. The embodiments presented in the present disclosure are provided to enable those skilled in the art to use or practice the content of the present disclosure. Accordingly, various modifications to embodiments of the present disclosure will be apparent to those skilled in the art. That is, the present disclosure may be implemented in various different forms and is not limited to the following embodiments.

The same or similar reference numerals denote the same or similar components throughout the specification of the present disclosure. Additionally, in order to clearly describe the present disclosure, reference numerals for parts that are not related to the description of the present disclosure may be omitted in the drawings.

The term “or” used herein is intended not to mean an exclusive “or” but to mean an inclusive “or.” That is, unless otherwise specified herein or the meaning is not clear from the context, the clause “X uses A or B” should be understood to mean one of the natural inclusive substitutions. For example, unless otherwise specified herein or the meaning is not clear from the context, the clause “X uses A or B” may be interpreted as any one of a case where X uses A, a case where X uses B, and a case where X uses both A and B.

The term “at least one of A and B” used herein should be interpreted to refer to all of A, B, and a combination of A and B.

The term “and/or” used herein should be understood to refer to and include all possible combinations of one or more of listed related concepts.

The terms “include” and/or “including” used herein should be understood to mean that specific features and/or components are present. However, the terms “include” and/or “including” should be understood as not excluding the presence or addition of one or more other features, one or more other components, and/or combinations thereof.

Unless otherwise specified herein or unless the context clearly indicates a singular form, the singular form should generally be construed to include “one or more.”

The term “N-th (N is a natural number)” used herein can be understood as an expression used to distinguish the components of the present disclosure according to a predetermined criterion such as a functional perspective, a structural perspective, or the convenience of description. For example, in the present disclosure, components performing different functional roles may be distinguished as a first component or a second component. However, components that are substantially the same within the technical spirit of the present disclosure but should be distinguished for the convenience of description may also be distinguished as a first component or a second component.

Meanwhile, the term “module” or “unit” used herein may be understood as a term referring to an independent functional unit processing computing resources, such as a computer-related entity, firmware, software or part thereof, hardware or part thereof, or a combination of software and hardware. In this case, the “module” or “unit” may be a unit composed of a single component, or may be a unit expressed as a combination or set of multiple components. For example, in the narrow sense, the term “module” or “unit” may refer to a hardware component or set of components of a computing device, an application program performing a specific function of software, a procedure implemented through the execution of software, a set of instructions for the execution of a program, or the like. Additionally, in the broad sense, the term “module” or “unit” may refer to a computing device itself constituting part of a system, an application running on the computing device, or the like. However, the above-described concepts are only examples, and the concept of “module” or “unit” may be defined in various manners within a range understandable to those skilled in the art based on the content of the present disclosure.

The term “model” used herein may be understood as a system implemented using mathematical concepts and language to solve a specific problem, a set of software units intended to solve a specific problem, or an abstract model for a process intended to solve a specific problem. For example, a neural network “model” may refer to an overall system implemented as a neural network that is provided with problem-solving capabilities through training. In this case, the neural network may be provided with problem-solving capabilities by optimizing parameters connecting nodes or neurons through training. The neural network “model” may include a single neural network, or a neural network set in which multiple neural networks are combined together.

The foregoing descriptions of the terms are intended to help to understand the present disclosure. Accordingly, it should be noted that unless the above-described terms are explicitly described as limiting the content of the present disclosure, the terms in the content of the present disclosure are not used in the sense of limiting the technical spirit of the present disclosure.

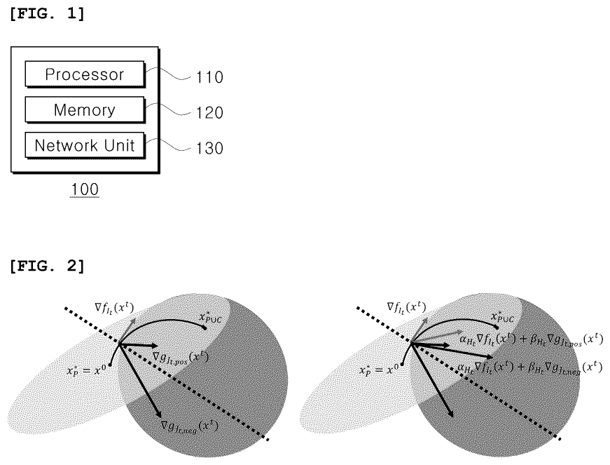

FIG. 1 is a block diagram of a computing device according to an embodiment of the present disclosure.

A computing device 100 according to an embodiment of the present disclosure may be a hardware device or part of a hardware device that performs the comprehensive processing and calculation of data, or may be a software-based computing environment that is connected to a communication network. For example, the computing device 100 may be a server that performs an intensive data processing function and shares resources, or may be a client that shares resources through interaction with a server. Furthermore, the computing device 100 may be a cloud system in which a plurality of servers and clients interact with each other and comprehensively process data. Since the above descriptions are only examples related to the type of computing device 100, the type of computing device 100 may be configured in various manners within a range understandable to those skilled in the art based on the content of the present disclosure.

Referring to FIG. 1, the computing device 100 according to an embodiment of the present disclosure may include a processor 110, memory 120, and a network unit 130. However, FIG. 1 shows only an example, and the computing device 100 may include other components for implementing a computing environment. Furthermore, only some of the components disclosed above may be included in the computing device 100.

The processor 110 according to an embodiment of the present disclosure may be understood as a configuration unit including hardware and/or software for performing computing operation. For example, the processor 110 may read a computer program and perform data processing for machine learning. The processor 110 may process computational processes such as the processing of input data for machine learning, the extraction of features for machine learning, and the calculation of errors based on backpropagation. The processor 110 for performing such data processing may include a central processing unit (CPU), a general purpose graphics processing unit (GPGPU), a tensor processing unit (TPU), an application specific integrated circuit (ASIC), or a field programmable gate array (FPGA). Since the types of processor 110 described above are only examples, the type of processor 110 may be configured in various manners within a range understandable to those skilled in the art based on the content of the present disclosure.

The processor 110 may train an artificial neural network based on a memory-based continual learning algorithm. Continual learning means that an artificial neural network is continuously trained based on new training data. In the present invention, continual learning may include, but is not limited to, a method of storing training data used in a previous task and reusing the previous training data in learning for a new task.

The processor 110 may store part of previous training data in the memory 120 and train an artificial neural network based on the data stored in the memory 120 and new training data according to the continual learning algorithm proposed in the present disclosure. In this case, the processor 110 may train the artificial neural network with the adaptive learning rate being reflected in the gradient for each type of data. The adaptive learning rate may refer to the weight that is imposed on the gradient for each type of data.

The processor 110 may compute the size of each adaptive learning rate so that the performance of the artificial neural network does not deteriorate as the training of the artificial neural network progresses. Furthermore, each adaptive learning rate may vary as the training of the artificial neural network progresses.

Meanwhile, the processor 110 may use indicators that can evaluate performance during the process of training the artificial neural network. More specifically, the processor 110 may calculate the bias of the artificial neural network that occurs when the previous training data stored in the memory 120 is used. The bias may refer to the learning error that may occur due to the use of part of data. Meanwhile, as parameters are updated using new training data, the performance of the artificial neural network model for the previous training data decreases, which may be called the degree of forgetting. The processor 110 may calculate the average degree of forgetting.

The memory 120 according to an embodiment of the present disclosure may be understood as a configuration unit including hardware and/or software for storing and managing data that is processed in the computing device 100. That is, the memory 120 may store any type of data generated or computed by the processor 110 and any type of data received by the network unit 130. For example, the memory 120 may include at least one type of storage medium of a flash memory type, hard disk type, multimedia card micro type, and card type memory, random access memory (RAM), static random access memory (SRAM), read-only memory (ROM), electrically erasable programmable read-only memory (EEPROM), programmable read-only memory (PROM), magnetic memory, a magnetic disk, and an optical disk. Furthermore, the memory 120 may include a database system that controls and manages data in a predetermined system. Since the types of memory 120 described above are only examples, the type of memory 120 may be configured in various manners within a range understandable to those skilled in the art based on the content of the present disclosure.

The memory 120 according to the present disclosure may store previous training data used in previous training. For example, the memory 120 may store part of previous training data. Furthermore, the memory 120 may store part of new training data.

The memory 120 may store training data, particularly previous training data, by using a ring buffer or reservoir sampling method. For example, the memory 120 may store an increasing number of pieces of new training data as the training of the artificial neural network progresses. Alternatively, the memory 120 may decrease the proportion of previous training data and increase the proportion of new training data as the training of the artificial neural network progresses.

The network unit 130 according to an embodiment of the present disclosure may be understood as a configuration unit that transmits and receives data through any type of known wired/wireless communication system. For example, the network unit 130 may perform data transmission and reception using a wired/wireless communication s a local area network (LAN), a wideband code division multiple access (WCDMA) network, a long term evolution (LTE) network, the wireless broadband (WiBro) Internet, a 5th generation mobile communication (5G) network, an ultra-wide band wireless communication network, a ZigBee network, a radio frequency (RF) communication network, a wireless LAN, a wireless fidelity network, a near field communication (NFC) network, or a Bluetooth network. Since the above-described communication systems are only examples, the wired/wireless communication system for the data transmission and reception of the network unit 130 may be applied in various manners other than the above-described examples.

The network unit 130 may receive previous training data or new training data from the outside. Meanwhile, the parameters of a trained artificial neural network may be transmitted to the outside.

According to the present disclosure, the adaptive learning rate for previous training data and the adaptive learning rate for new training data may be set individually, so that continual learning may be performed without losing performance on the previous training data. Furthermore, the performance of the artificial neural network may be maximized by adjusting the adaptive learning rates at each stage of learning. Furthermore, the performance may be objectively evaluated by presenting indicators that can quantify learning performance, such as bias and the degree of forgetting.

FIG. 2 is an exemplary diagram illustrating a method of training an artificial neural network according to an embodiment of the present disclosure.

Referring to FIG. 2, the left ellipse may represent the area of parameters exhibiting desirable performance on previous training data, and the right circle may correspond to the area of parameters exhibiting desirable performance on new training data. In other words, the goal of the continual learning algorithm according to the present disclosure may be to set the parameters so that the parameters are located in the area where the left ellipse and the right circle overlap each other.

In FIG. 2, P denotes previous training data, C denotes new training data, x^{t} denotes the parameters of an artificial neural network model, and x_{P}* denotes a local optimum point through previous training. The previous training data and the new training data may each be in the form of a data stream.

∇f_{I}_{ₜ}(x^{t}) may denote the gradient of the artificial neural network trained using the previous training data, and ∇g_{J}_{ₜ}(x^{t}) may denote the gradient of the artificial neural network trained using the new training data. t denotes the number of iterations. It is expected that as t progresses, x_{P}* reaches a new optimal point x_{P∪C}*. x_{P∪C}* is located in the area where the left ellipse and the right circle overlap each, so that desirable performance can be exhibited on both the previous training data and the new training data. As shown on the left drawing of FIG. 2, for a new training data batch in a t-th iteration, x^{t} may have ∇g_{J}_{_{t.}}ₚₒₛ(x^{t}) or ∇g_{J}_{ₜ}_{neg}(x^{t}). ∇g_{J}_{_{t.}}ₚₒₛ(x^{t}) or ∇g_{J}_{ₜ}_{neg}(x^{t}) may be computed depending on whether the value of [symbol] ∇f_{I}_{ₜ}(x^{t}), ∇g_{J}_{ₜ}(x^{t}) [symbol] is positive or negative.

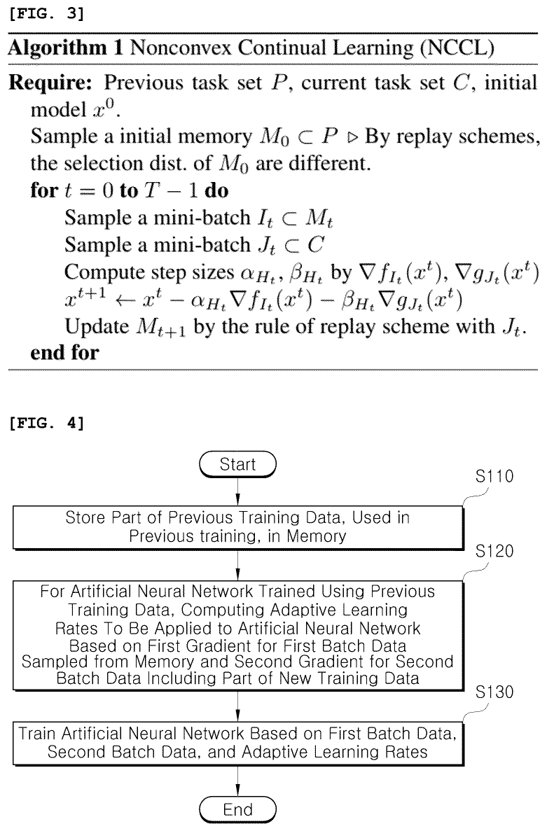

The continual learning algorithm according to the present disclosure may apply the adaptive learning rate to the gradient so that x^{t} is located as indicated by the second and fourth arrows clockwise from the 12 o'clock position, as shown in the right drawing. The continual learning algorithm according to the present disclosure will be described in detail with reference to FIGS. 3 to 6.

FIG. 3 is an exemplary diagram showing an algorithm for a method of training an artificial neural network according to an embodiment of the present disclosure.

Since each parameter in FIG. 3 is similar to that described in FIG. 2, only different parts will be described. Referring to FIG. 3, there is shown pseudocode describing the continual learning algorithm according to the present disclosure.

The part of the previous training data stored in the memory is called M₀, the first batch data extracted from M₀ is called Iₜ, and the second batch data containing the part of the new training data is called Jₜ. A sampling method for generating the first batch data and the second batch data is not limited to a specific method.

The algorithm iterates from t=0 to t=T−1, and the first batch data and the second batch data are updated for each step. The computing device 100 calculates a first adaptive learning rate (a first step size) based on a first gradient for the first batch data and a second adaptive learning rate (a second step size) based on a second gradient for the second batch data. In this case, Hₜ denotes the union of the first batch data and the second batch data.

In this disclosure, the terms “first gradient” and “second gradient” do not refer to the first or second derivatives, but rather denote the gradient associated with the first batch of data and the gradient associated with the second batch of data, respectively.

Furthermore, the computing device 100 updates the parameters of the artificial neural network by using the first adaptive learning rate and the second adaptive learning rate. In other words, the values output from the present algorithm are the parameters of the artificial neural network for which continual learning according to this disclosure has been completed.

According to the present disclosure, to calculate the parameters at time t+1, the adaptive learning rates calculated based on the gradients are adapted to the gradients, so that the algorithm proposed in the present disclosure may be referred to as adaptive stochastic gradient descent.

FIG. 4 is a flowchart showing a method of training an artificial neural network according to an embodiment of the present disclosure.

Referring to FIG. 4, the computing device 100 may train an artificial neural network based on a memory-based continual learning algorithm. In this case, the memory may operate using a ring buffer or reservoir sampling method.

In step S110, the computing device 100 may store part of previous training data used in previous training in the memory.

In step S120, the computing device 100 may compute adaptive learning rates to be applied to the artificial neural network based on a first gradient for first batch data sampled from the memory and a second gradient for second batch data including part of new training data for the artificial neural network trained using previous training data.

More specifically, the computing device 100 may compute a first adaptive learning rate to be reflected in the first gradient and a second adaptive learning rate to be reflected in the second gradient based on the inner product of the first and second gradients. For example, when the inner product of the first and second gradients is larger than 0, the first adaptive learning rate may be computed to be a constant. When the inner product of the first and second gradients is equal to or smaller than 0, the second adaptive learning rate may be computed to be a constant. More specifically, the first adaptive learning rate α_{H}_{ₜ} and the second adaptive learning rate β_{H}_{ₜ} may be calculated according to Equation 1 below:

$${α}_{{H}_{t}} = \{ \begin{matrix}α ( 1 - \frac{{Λ}_{{H}_{t}}}{{‖ ∇ {f}_{{I}_{t}} ( {x}^{t} ) ‖}^{2}} ) , & {Λ}_{{H}_{t}} \leq 0 \\ α , & {Λ}_{{H}_{t}} > 0 ,\end{matrix} \\ {β}_{{H}_{t}} = \{ \begin{matrix}α , & {Λ}_{{H}_{t}} \leq 0 \\ min ( α ( 1 - δ ) , \frac{( 1 - α L ) {Λ}_{{H}_{t}}}{L {‖ ∇ {g}_{{J}_{t}} ( {x}^{t} ) ‖}^{2}} ) , & {Λ}_{{H}_{t}} > 0\end{matrix} \qquad ( 1 )$$

In Equation 1, α denotes the basic constant learning rate (a constant), ∇f_{I}_{ₜ}(x^{t}) denotes the first gradient, ∇g_{J}_{ₜ}(x^{t}) denotes the second gradient, Λ_{H}_{ₜ} denotes the inner product of the first and second gradients, and δ denotes a constant larger than 0 and considerably smaller than 1.

The process of obtaining Equation 1 will be briefly described below. The degree of convergence at step t is calculated as in Equation 2, and has an upper limit.

$${t}_{} {‖ ∇ f ( {x}^{t} ) ‖}^{2} \leq {t}_{} [ \frac{f ( {x}^{t} ) - f ( {x}^{t + 1} + {B}_{t} + {Γ}_{t} )}{{α}_{{H}_{t}} ( 1 - \frac{L}{2} {α}_{{H}_{t}} )} ] + {t}_{} [ \frac{{α}_{{H}_{t}} L}{2 ( 1 - \frac{L}{2} {α}_{{H}_{t}} )} {α}_{f}^{2} ] \qquad ( 2 )$$

[symbol] ₜ∥∇f(x^{t})∥² may denote the degree of convergence.

In Equation 2, the terms related to bias error may be collected and organized. The bias error may refer to the bias error between the average gradient ∇f(x^{t}) for the overall previous training data P of the parameters x^{t} of the artificial neural network at step t and the gradient of part of the previous training data P.

In Equation 2, the term in which the expressions related to the bias error are collected is called Bₜ, and may be referred to as a bias term. The term in which the remaining terms excluding the bias term are collected is called Γₜ, and may be referred as a forgetting term. The forgetting term may have the influence of impairing convergence on P when a new task is learned. That is, the bias term and the forgetting term may be arranged as Equation 3 and Equation 4, respectively.

$${B}_{t} = ( L {α}_{{H}_{t}}^{2} - {α}_{{H}_{t}} ) 〈 ∇ {f}_{{I}_{t}} ( {x}^{t} ) , {e}_{t} 〉 + {β}_{{H}_{t}} 〈 ∇ {g}_{{J}_{t}} ( {x}^{t} ) , {e}_{t} 〉 \qquad ( 3 )$$

In Equation 3, L denotes a Lipschitz smoothness constant, and eₜ may denote the bias error between the average gradient ∇f(x^{t}) for the previous training data and the first gradient.

In the present specification, the bias term may be referred to as bias. According to Equation 3, the bias Bₜ of the artificial neural network that occurs as the first batch data is used may be calculated.

Furthermore, the degree of forgetting for the previous training data of the artificial neural network model caused by the second batch data may be calculated by Equation 4. That is, the forgetting term Γₜ of convergence for the previous training data calculated in step t may be calculated according to Equation 4 below:

$${Γ}_{t} = \frac{{β}_{{H}_{t}}^{2} L}{2} {‖ ∇ {g}_{{J}_{t}} ( {x}^{t} ) ‖}^{2} - {β}_{{H}_{t}} ( 1 - {α}_{{H}_{t}} L ) 〈 ∇ {f}_{{I}_{t}} ( {x}^{t} ) , ∇ {g}_{{J}_{t}} ( {x}^{t} ) 〉 \qquad ( 4 )$$

Meanwhile, the upper limit of convergence for the previous training data P is not substantially influenced by the bias term Bₜ, but may be increased by the forgetting term Σ [symbol] [Γₜ] accumulated according to step t. Accordingly, the continual learning algorithm according to the present disclosure may operate with the goal of reducing the forgetting term [symbol] [Γₜ] accumulated at each step.

When the sign of the inner product of the first and second gradients is larger than 0, the optimal value β_{H}_{ₜ}* of the second adaptive learning rate is calculated as shown in Equation 5 below. The forgetting term to which this optimal value β_{H}_{ₜ}*, is applied becomes the minimum forgetting value, and the minimum forgetting value in this case may be referred to as the average degree E[Γₜ*] of forgetting. The average degree E[Γₜ*] of forgetting may be calculated as in Equation 6 below:

$${β}_{{H}_{t}}^{*} = \frac{( 1 - {α}_{{H}_{t}} L ) {Λ}_{{H}_{t}}}{L {‖ ∇ {g}_{{J}_{t}} ( {x}^{t} ) ‖}^{2}} \qquad ( 5 )$$

$$E [ {Γ}_{t}^{*} ] = \frac{( 1 - {α}_{{H}_{t}} L ) {Λ}_{{H}_{t}}}{2 L {‖ ∇ {g}_{{J}_{t}} ( {x}^{t} ) ‖}^{2}} \qquad ( 6 )$$

Meanwhile, when the inner product of the first and second gradients is smaller than 0, there is no minimum point at the point where the quadratic expression of the forgetting term is larger than 0, so that the adaptive learning rate can be set to allow ∇g_{J}_{ₜ}(x^{t}) to remove only the components that worsen the convergence for P.

Returning to FIG. 4, the computing device 100 may train the artificial neural network based on the first batch data, the second batch data, and the adaptive learning rate in step S130.

That is, the computing device 100 may update the parameters of the artificial neural network according to Equation 7 below:

$${x}^{t + 1} = {x}^{t} - {α}_{{H}_{t}} ∇ {f}_{{I}_{t}} ( {x}^{t} ) - {β}_{{H}_{t}} ∇ {g}_{{J}_{t}} ( {x}^{t} ) \qquad ( 7 )$$

In Equation 7, ∇f_{I}_{ₜ}(x^{t}) denotes the first gradient, ∇g_{J}_{ₜ}(x^{t}) denotes the second gradient, x^{t+1} denotes the updated parameters of the artificial neural network, x^{t} denotes the parameters of the artificial neural network before update, α_{H}_{ₜ} denotes the first adaptive learning rate, β_{H}_{ₜ} denotes the second adaptive learning rate, and Hₜ denotes the union of the first batch data and the second batch data.

The computing device 100 according to the present disclosure may perform learning at a current stage using at least part of new training data and at least part of previous training data used for learning at a previous stage.

That is, the computing device 100 may use at least part of the previous training data and at least part of the new training data to calculate the parameters the artificial neural network at the current stage. In this case, the extracted part of each type of training data is called batch data. The size of the batch data extracted from the new training data and the size of the batch data extracted from the previous training data may be different from each other, and may vary depending on the memory method. Furthermore, as training progresses, the proportion of each type of batch data may change.

In this case, in the process of updating the parameters, the computing device 100 may compute the adaptive learning rate using the gradient for each type of batch data. The adaptive learning rate may be applied to the gradient for each type of batch of data. According to the present disclosure, the adaptive learning rate may be computed within a range within which convergence for the previous training data is not lost. The adaptive learning rate may be set such that there is no bias in data convergence that may be caused by memory size. Furthermore, to minimize the deterioration of performance on the previous training data as training iterates, the adaptive learning rate may be set to minimize the cumulative size of forgetting term that impairs convergence.

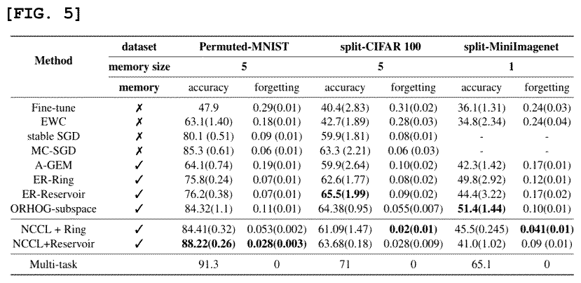

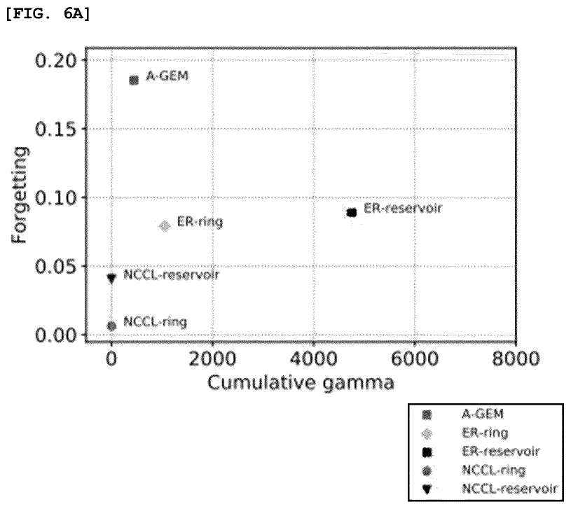

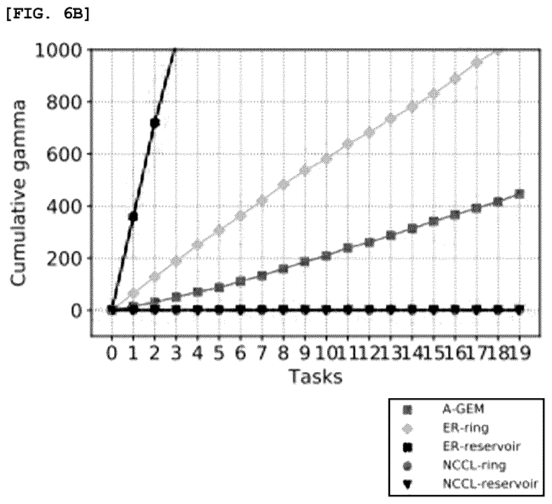

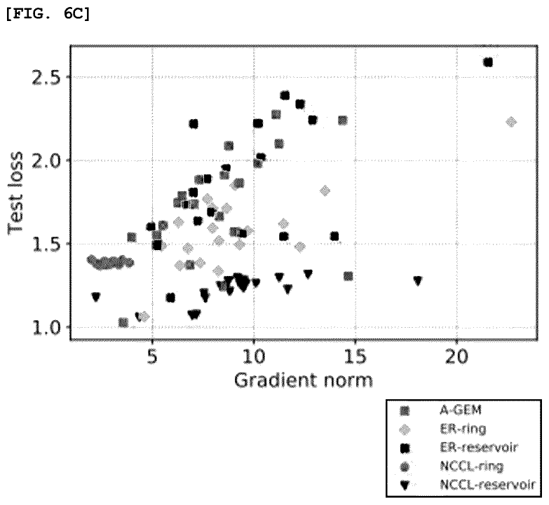

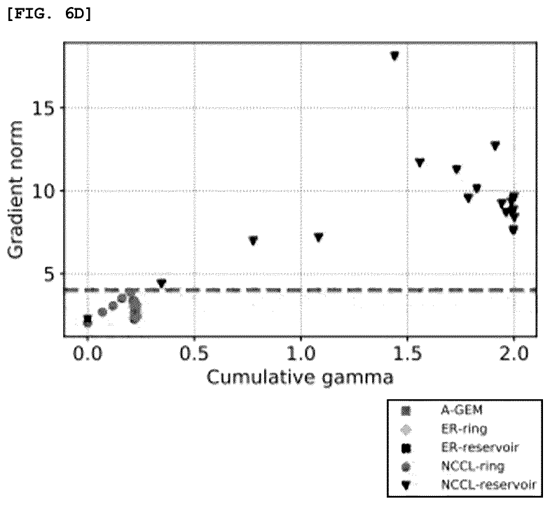

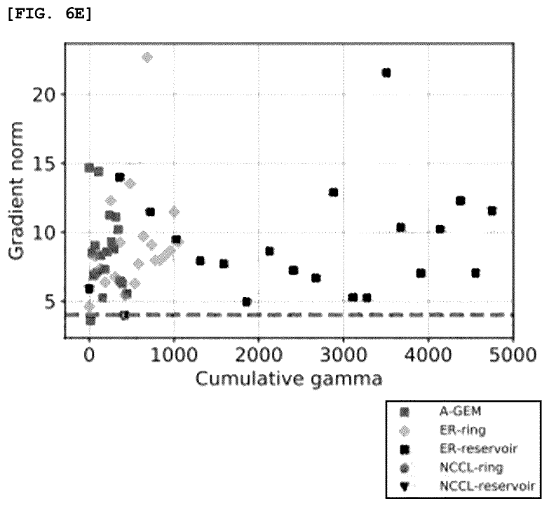

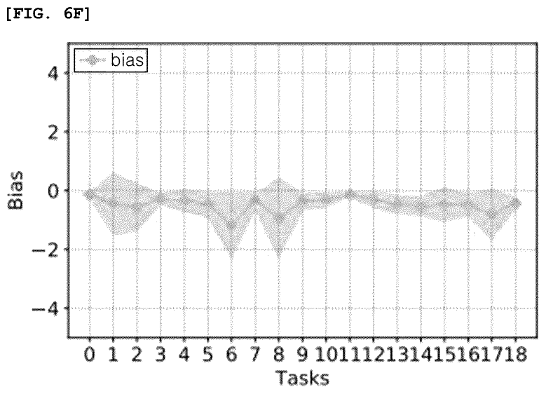

FIG. 5 is a table showing the performance of a method of training an artificial neural network according to an embodiment of the present disclosure, and FIGS. 6A through 6F are graphs showing the performance of a method of training an artificial neural network according to an embodiment of the present disclosure.

Referring to FIG. 5, the performance of the memory-based continual learning algorithm according to the present disclosure is shown compared to other conventional learning algorithms. NCCL denotes the algorithm (nonconvex continual learning) according to the present disclosure, NCCL+Ring denotes the case of operation using a ring buffer-based memory method, and NCCL+Reservoir denotes the case of operation using a reservoir sampling-based memory method. It can be seen that compared to the conventional algorithms, the memory-based continual learning algorithm provides high accuracy and low forgetting.

Referring to FIGS. 6A through 6F, there are shown various indicators that can compute the performances of an artificial neural network learned using the conventional learning algorithms and the algorithm proposed in the present disclosure. FIG. 6A shows the forgetting term Σ [symbol] [Γₜ] accumulated according to the degree of forgetting and step t, and FIG. 6B shows changes in [symbol] [Γₜ] learning progresses. FIG. 6C shows the relationship between ∥∇f(x)∥ for a first task and the test loss of the first task in a dataset called CIFAR-100, and FIGS. 6D and 6E empirically show Σ [symbol] [Γₜ] versus ∥∇f(x)∥ for the first task in the continual learning algorithm. FIG. 6F empirically shows Bₜ when each task is terminated.

According to the present disclosure, adaptive learning rates may be set for previous training data and new training data, respectively, and the performance of an artificial neural network may be maximized by adjusting the adaptive learning rates at each stage of learning.

Furthermore, according to the present disclosure, the objective evaluation of performance of a learning algorithm may be performed by providing quantifiable indicators that can evaluate learning performance.

The various embodiments of the present disclosure described above may be combined with one or more additional embodiments, and may be changed within the scope understandable to those skilled in the art in light of the above detailed description. The embodiments of the present disclosure should be understood as illustrative but not restrictive in all respects. For example, individual components described as unitary may be implemented in a distributed manner, and similarly, components described as distributed may also be implemented in a combined form. Accordingly, all changes or modifications derived from the meanings and scopes of the claims of the present disclosure and their equivalents should be construed as being included in the scope of the present disclosure.

What is claimed is:

1. A method of training an artificial neural network based on a memory-based continual learning algorithm, the method being performed by a computing device including at least one processor, the method comprising:
storing part of previous training data, used in previous training, in memory;
for an artificial neural network trained using the previous training data, computing adaptive learning rates to be applied to the artificial neural network based on a first gradient for first batch data sampled from the memory and a second gradient for second batch data including part of new training data; and
training the artificial neural network based on the first batch data, the second batch data, and the adaptive learning rates.

2. The method of claim 1, wherein computing the adaptive learning rates comprises computing a first adaptive learning rate to be reflected in the first gradient and a second adaptive learning rate to be reflected in the second gradient based on an inner product of the first and second gradients.

3. The method of claim 2, wherein computing the first adaptive learning rate to be reflected in the first gradient and the second adaptive learning rate to be reflected in the second gradient comprises computing the first adaptive learning rate to be a constant when the inner product of the first and second gradients is larger than 0 and computing the second adaptive learning rate to be a constant when the inner product of the first and second gradients is smaller than or equal to 0.

4. The method of claim 3, wherein the first adaptive learning rate is calculated according to Equation 1 below when the inner product of the first and second gradients is smaller than or equal to 0:
$$α ( 1 - \frac{{Λ}_{{H}_{t}}}{{‖ ∇ {f}_{{I}_{t}} ( {x}^{t} ) ‖}^{2}} ) \qquad ( 1 )$$
where:
α: a basic constant learning rate (a constant)
Λ_{H}_{ₜ}: the inner product of the first gradient ∇f_{I}_{ₜ}(x^{t}) and the second gradient ∇g_{J}_{ₜ}(x^{t})
∇f_{I}_{ₜ}(x^{t}): the first gradient.

5. The method of claim 3, wherein the second adaptive learning rate is calculated according to Equation 2 below when the inner product of the first and second gradients is larger than 0:
$$min ( α ( 1 - δ ) , \frac{( 1 - α L ) {Λ}_{{H}_{t}}}{L {‖ ∇ {g}_{{J}_{t}} ( {x}^{t} ) ‖}^{2}} ) \qquad ( 2 )$$
where:
α: a basic constant learning rate (a constant)
δ: a constant larger than 0 and considerably smaller than 1
L: a Lipschitz smoothness constant
∇f_{I}_{ₜ}(x^{t}): the first gradient
∇g_{J}_{ₜ}(x^{t}): the second gradient
Λ_{H}_{ₜ}: the inner product of the first and second gradients.

6. The method of claim 2, wherein training the artificial neural network comprises updating parameters of the artificial neural network according to Equation 3 below:
$${x}^{t + 1} = {x}^{t} - {α}_{{H}_{t}} ∇ {f}_{{I}_{t}} ( {x}^{t} ) - {β}_{{H}_{t}} ∇ {g}_{{J}_{t}} ( {x}^{t} ) \qquad ( 3 )$$
where:
∇f_{I}_{ₜ}(x^{t}): the first gradient
∇g_{J}_{ₜ}(x^{t}): the second gradient
x^{t+1}: the updated parameters of the artificial neural network
x^{t}: the parameters of the artificial neural network before update
α_{H}_{ₜ}: the first adaptive learning rate
β_{H}_{ₜ}: the second adaptive learning rate
Hₜ: a union of the first batch data and the second batch data.

7. The method of claim 1, wherein a bias Bₜ of the artificial neural network that occurs as the first batch data is used is calculated according to Equation 4 below:
$${B}_{t} = ( L {α}_{{H}_{t}}^{2} - {α}_{{H}_{t}} ) 〈 ∇ {f}_{{I}_{t}} ( {x}^{t} ) , {e}_{t} 〉 + {β}_{{H}_{t}} 〈 ∇ {g}_{{J}_{t}} ( {x}^{t} ) , {e}_{t} 〉 \qquad ( 4 )$$
where:
L: a Lipschitz smoothness constant
α_{H}_{ₜ}: the first adaptive learning rate
β_{H}_{ₜ}: the second adaptive learning rate
∇f_{I}_{ₜ}(x^{t}): the first gradient
∇g_{J}_{ₜ}(x^{t}): the second gradient
eₜ: bias error between an average gradient ∇f(x^{t}) for the previous training data and the first gradient.

8. The method of claim 1, wherein a forgetting term Γₜ of convergence for the previous training data calculated in step t, which is used to calculate an average degree of forgetting for the previous training data of the artificial neural network model caused by the second batch data, is calculated according to Equation 5 below:
$${Γ}_{t} = \frac{{β}_{{H}_{t}}^{2} L}{2} {‖ ∇ {g}_{{J}_{t}} ( {x}^{t} ) ‖}^{2} - {β}_{{H}_{t}} ( 1 - {α}_{{H}_{t}} L ) 〈 ∇ {f}_{{I}_{t}} ( {x}^{t} ) , ∇ {g}_{{J}_{t}} ( {x}^{t} ) 〉 \qquad ( 5 )$$
where:
α_{H}_{ₜ}: the first adaptive learning rate
β_{H}_{ₜ}: the second adaptive learning rate
L: a Lipschitz smoothness constant
∇f_{I}_{ₜ}(x^{t}): the first gradient
∇g_{J}_{ₜ}(x^{t}): the second gradient.

9. The method of claim 8, wherein the average degree of forgetting E[Γₜ*] is calculated according to Equation 7 below when the second adaptive learning rate is an optimal value β_{H}_{ₜ}* represented by Equation 6 below:
$${β}_{{H}_{t}}^{*} = \frac{( 1 - {α}_{{H}_{t}} L ) {Λ}_{{H}_{t}}}{L {‖ ∇ {g}_{{J}_{t}} ( {x}^{t} ) ‖}^{2}} \qquad ( 6 )$$
$$E [ {Γ}_{t}^{*} ] = \frac{( 1 - {α}_{{H}_{t}} L ) {Λ}_{{H}_{t}}}{2 L {‖ ∇ {g}_{{J}_{t}} ( {x}^{t} ) ‖}^{2}} \qquad ( 7 )$$
where:
Γₜ*: a minimum value of the forgetting term of the convergence calculated at step t
Λ_{H}_{ₜ}: the inner product of the first and second gradients.

10. The method of claim 1, wherein the memory stores the previous training data by using a ring buffer or reservoir sampling method.

11. A computer program stored in a computer-readable storage medium, the computer program performing operations of training an artificial neural network based on a memory-based continual learning algorithm when executed on at least one processor,
wherein the operations comprise operations of:
storing part of previous training data, used in previous training, in memory;
for an artificial neural network trained using the previous training data, computing adaptive learning rates to be applied to the artificial neural network based on a first gradient for first batch data sampled from the memory and a second gradient for second batch data including part of new training data; and
training the artificial neural network based on the first batch data, the second batch data, and the adaptive learning rates.

12. A computing device for training an artificial neural network based on a memory-based continual learning algorithm, the computing device comprising:
a processor including at least one core; and
memory including program codes that are executable on the processor, and configured to store part of previous training data used in previous training;
wherein the processor computes, for an artificial neural network trained using the previous training data, adaptive learning rates to be applied to the artificial neural network based on a first gradient for first batch data sampled from the memory and a second gradient for second batch data including part of new training data, and trains the artificial neural network based on the first batch data, the second batch data, and the adaptive learning rates.
